(19) United States
(12) Patent Application Publication
(10) Pub. No.: US 2018/0290424 A1
(43) Pub. Date: Oct. 11, 2018

(54) NON WOVEN POLYMER LAMINATED BAGS

(71) Applicant: JUNG SHIN CO. LTD., Seoul (KR)

(72) Inventor: SONG-HYUK BANG, Seoul (KR)

(21) Appl. No.: 15/485,117

(22) Filed: Apr. 11, 2017

(51) Int. Cl. B32B 5/02; B32B 7/12; B32B 37/12; B32B 38/00; B32B 38/04

(52) U.S. Cl. CPC B32B 5/022; B32B 5/024; B32B 7/12; B32B 37/12; B32B 38/0004; B32B 2038/047; B32B 38/04; B32B 2323/00; B32B 2439/06; B32B 2038/008; B32B 38/145

(57) ABSTRACT

Bags for storing granular material are disclosed, the bags having an inner woven polymeric layer, an outer nonwoven polymeric layer, and an extruded polymer layer bonding the inner layer to the outer layer. Methods for forming the bags are also disclosed.

### BACKGROUND

Pelletized pet food and animal feed, and other granular products such as fertilizer, grain and industrial raw materials, are transported and stored in large bags, known as back seam laminated or circular laminated bags. Such bags may contain, for example, 20 pounds to 60 pounds or more of the product. It is thus important that the bag material have high tensile strength, in order to resist tearing or bursting of the bags during transport, and that it be possible to safely stack a large number of the bags without the bags sliding off of one another.

Traditionally, these bags were formed of a multi-layer laminate that included one or more paper layers. More recently, such paper-based laminates have been replaced by polymeric laminates. For example, some bags include a polymer film layer laminated to a woven layer by an extruded polymer “adhesive” layer. In some cases, these polymeric bags are formed of polypropylene for recyclability.

### SUMMARY

The present disclosure features laminated bags, e.g., back seam or circular laminated bags, having an inner woven layer laminated to an outer nonwoven layer. These bags are strong, resisting ripping and bursting during transport and storage. The bags also have a surface that is less slippery than that of film bags—making for easier and safer stacking of the bags back to back in warehouses and at retailers. Since the contents of laminated bags are often very heavy, the non-slip quality of the bags disclosed herein provides an important safety benefit by preventing injuries that could result from the collapse of a stack of bags. The bag surface is also easily printed on using a wide variety of printers. In some implementations, the bag is fully recyclable and/or biodegradable.

In one aspect, the disclosure features a bag for storing granular material, the bag comprising an inner woven polymeric layer, an outer nonwoven polymeric layer, and an adhesive layer bonding the inner layer to the outer layer.

In some implementations, the bag may include one or more of the following features.

The nonwoven layer may comprise a spunbonded material. The nonwoven layer may have a basis weight of from about 15 to 80 gsm (grams per square meter), for example from about 20 to 55 gsm, or from about 20 to 40 gsm (ASTM D3776). In some cases, the nonwoven layer has a grab tensile strength of at least 20 lb/in (ASTM D5034.) The nonwoven layer may be, for example, a polypropylene or polyethylene nonwoven.

The bag may have a volume of at least 3 gallons, for example at least 6 gallons or even 10 gallons or more. In some cases, the bag has a volume of from about 3 gallons to 30 gallons. In some implementations, the bag is perforated to provide breathability.

The three layers may be of the same material, e.g., all of polypropylene or all of polyethylene.

The inner woven layer may have a fabric weight of from about 27 to 135 gsm, e.g., from about 50 to 100 gsm. In some cases, the woven material is formed of fibers having a denier of about 500 to 1500, e.g., about 750 to 1250.

The adhesive layer may be an extruded polymer film, and may be present in an amount of about 15-25 gsm.

In another aspect, the disclosure features a method of making a laminated bag, the method comprising forming a laminated material by laminating a nonwoven layer to a woven layer using an extruded polymer layer, and forming the laminated material into a bag having the nonwoven layer as its outer surface.

In some implementations, forming the material into a bag includes forming the laminated material into a cylindrical shape with the nonwoven layer exposed, cutting the cylindrical shape to bag length, and sewing the laminated material to form individual bags. In some cases, the method further includes printing the laminated material and/or perforating the laminated material to provide air holes for breathability. The sewing step may include applying a finishing tape to the material edges in seam areas and stitching through the finishing tape.

### DESCRIPTION OF THE DRAWINGS

FIG. 1 is an exploded view of the woven and non-woven layers of a laminated material according to one implementation, with the finished laminated material shown diagrammatically in the circled area.

FIG. 2 is a cross-sectional view of the laminated material of FIG. 1, with an enlarged detail view shown in the circled area.

FIG. 3 is a diagrammatic perspective view of a cylinder formed of the laminated material during bag manufacture, with an enlarged detail view of the edge seam of the cylinder shown in the circled area.

FIG. 4 is a diagrammatic view of a bag pre-form B, with a finishing tape being applied to seam seal one end of the bag.

FIG. 5 is a diagrammatic view of a completed and filled bag, with the contents of the bag shown in phantom lines.

### DETAILED DESCRIPTION

As discussed above, the disclosure features back seam or circular laminated bags that are formed of a laminated material that includes an outer nonwoven layer and an inner woven layer, joined together by a laminating adhesive layer.

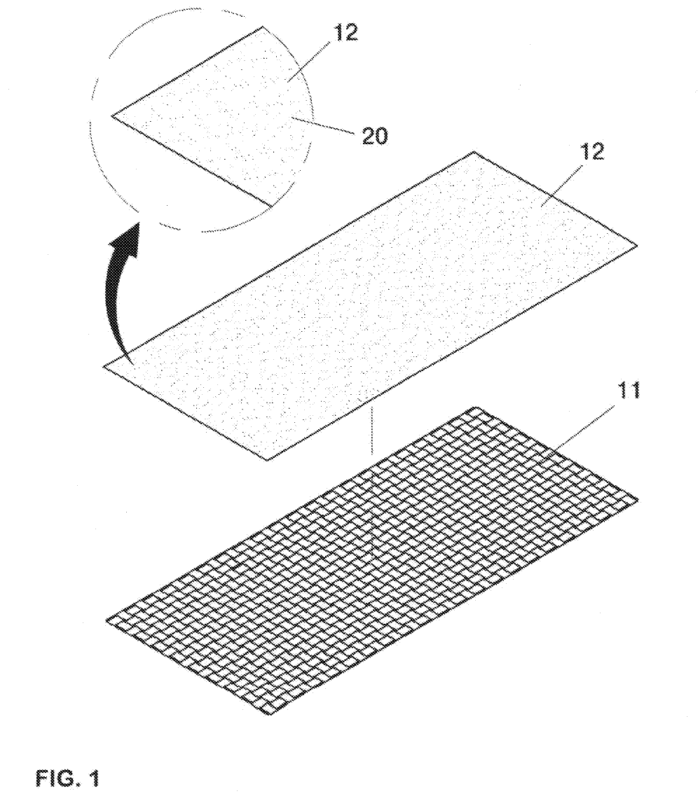

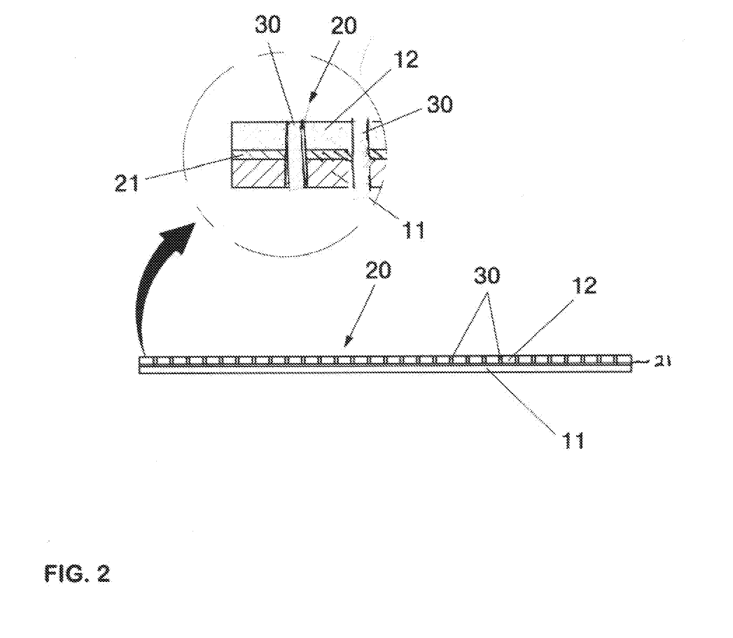

Referring to FIG. 1, a laminated material 20 includes a woven layer 11, a nonwoven layer 12, and an adhesive layer 21 (FIG. 2) interposed between layers 11 and 12. As shown in FIG. 2, the laminated material 20 may, optionally, include perforations 30 if breathability is required for a particular application. The perforations 30 extend through all three layers, and are formed after the layers have been laminated together.

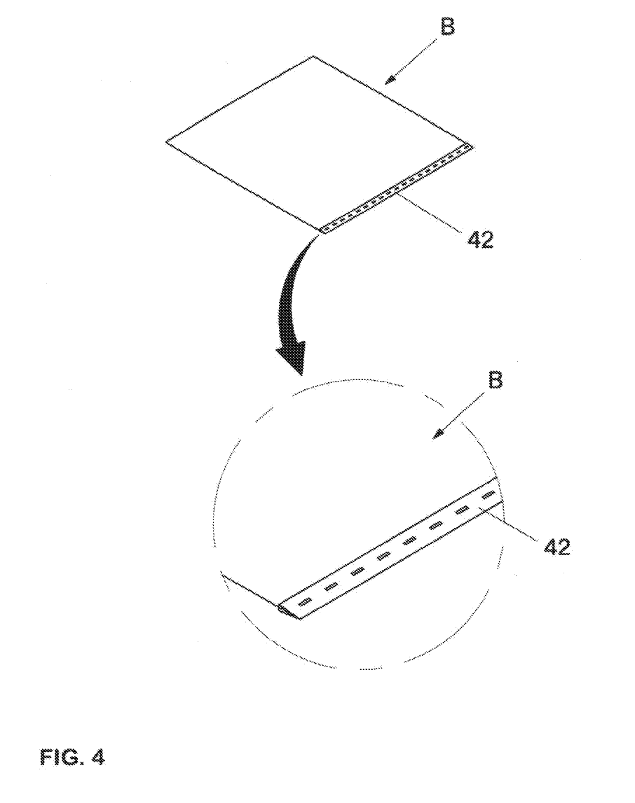

Referring to FIG. 4, the laminated material is used to form a finished bag 100, for example using the methods discussed in detail below, defining an inner volume V that can contain any desired granular material G. In the finished bag, the nonwoven layer 21 is disposed on the outside surface of the bag, providing the advantageous non-slip characteristics and printability discussed above. The surface roughness and coefficient of friction of the outer surface of the bag are higher than would be the case if the outer surface were a polymer film, paper, or woven layer, e.g., at least 5% higher than any of these surfaces, or in some cases higher by at least 10% or more. The nonwoven materials may, in some cases, have a Coefficient of Friction of at least 0.20, e.g., at least 0.25 or at least 0.30 and a Surface Roughness of at least 4, e.g., at least 5, at least 10, or at least 15 microns as measured in accordance with the Kawabata Evaluation System (KES) using a KES-FB4 Friction Tester with Roughness Sensor (available from Kato Tech Co., Japan).

We will first discuss below methods of manufacturing the laminate, followed by examples of materials that may be used, and lastly examples of methods by which the bag may be manufactured.

Laminate Manufacture

Layers 11 and 12 are laminated together using adhesive layer 21, which is preferably a polymer film. Lamination may be performed, for example, by passing the three layers through a pair of nip rolls, with heat and pressure being applied to the layers at the nip. In some implementations, the laminating temperature would be from about 250 to 325 degrees Celcius, e.g., from about 270 to 300 degrees Celcius. Standard laminating pressures are applied.

Materials

It is generally preferred that the laminate be formed entirely of recyclable polymers, for example polypropylene and polyethylene, e.g., low density polyethylene (LDPE). It is also generally preferred, in order to obtain good adhesion between the layers, that the three layers be formed of the same polymer.

The nonwoven layer may be a spunbonded material. In order to provide the bag with the desired non-slip surface characteristics, it is important that the nonwoven layer have a basis weight that provides it with a relatively rough surface. In some implementations, the basis weight (ASTM D3776) is at least about 15 gsm, e.g., at least about 20 gsm. It is also preferred that the basis weight be as low as possible without unacceptably compromising non-slip characteristics, so as to minimize the cost of the bag and transportation costs. Thus, it is generally preferred that the nonwoven layer have a basis weight of from about 15 to 80 gsm (grams per square meter), for example from about 20 to 55 gsm, or from about 20 to 40 gsm.

It is also preferred that the nonwoven layer have relatively high tensile strength, so that the nonwoven layer can contribute to the strength of the bag. In some cases, the nonwoven layer has a grab tensile strength of at least 20 lb/in (ASTM D5034.)

The adhesive layer is preferably an extruded polymer film, for example a LDPE or polypropylene adhesive grade extruded film. The polymer used is generally selected to be the same as the polymer of the woven fabric layer. The adhesive layer is of a thickness selected to provide enough of the polymer to securely bond the woven and nonwoven layers. Generally, this corresponds to the adhesive layer having a weight of from about 15 to 25 gsm.

The woven layer may have a fabric weight of from about 27 to 135 gsm, e.g., from about 50 to 100 gsm. In some cases, the woven material is formed of fibers having a denier of about 500 to 1500, e.g., about 750 to 1250.

Because of the strength imparted by the nonwoven, in some implementations a relatively low tensile strength woven layer may be used while still maintaining a desired level of overall bag strength. Using a thinner woven layer can help to reduce both the cost of the bag and shipping costs.

Bag Manufacture

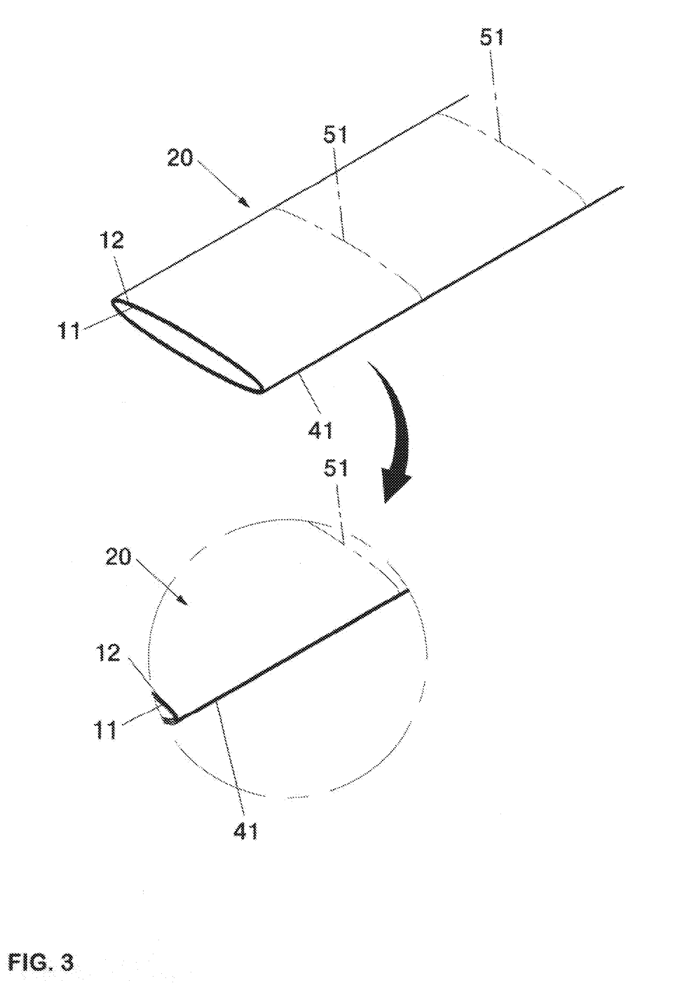

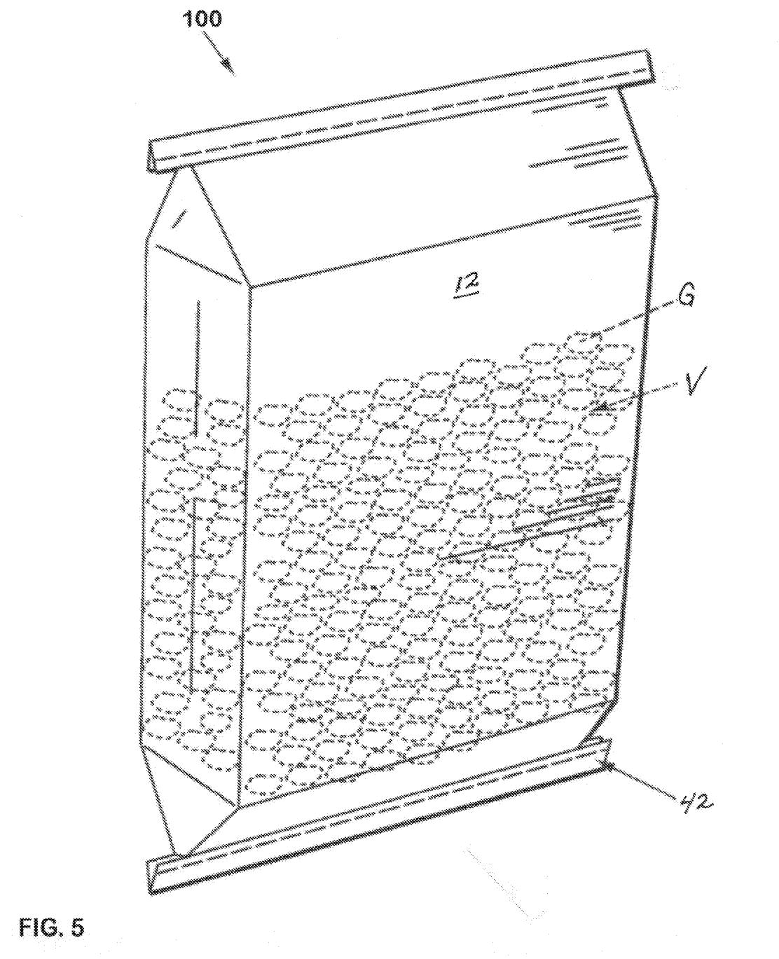

Referring to FIG. 3, an initial step in the manufacture of bag 100 (FIG. 5) is to use a mandrel to roll the laminated material 20 into a generally cylindrical shape, with nonwoven layer 12 on the outside of the cylinder. (While the shape shown in FIG. 3 is referred to as cylindrical for the sake of simplicity, it is actually a flattened cylinder with a generally oval cross-sectional shape.) As shown in the detail in FIG. 3, the rolled material has a seam 41 along one of its long edges. It is generally preferred that the two edges overlap each over by about 1 to 2 inches at the seam 41. The seam 41 may be made, for example, by extruder lamination welding. The cylinder is then cut at regular intervals, as indicated by lines 51, corresponding to the desired bag length.

In some embodiments, e.g., when it is desired that the bag be porous to air and moisture but still impervious to water, very fine perforations are formed in the laminated material prior to the initial bag formation step. The number and size of perforations will depend on the particular application, for example the intended bag contents and degree of breathability that is needed.

It is generally preferred that the bag be printed, for example with images and or lettering denoting the contents of the bag, the manufacturer of the product, etc. Printing may be performed with, for example, digital printers, ink jet printers, offset printers or flexographic printers. The nonwoven layer 12 provides good ink receptivity and allows clear and vivid printed images to be obtained. Printing can be performed prior to or after bag formation. In some cases, a coating is applied to the nonwoven layer prior to printing to enhance print quality and/or increase the ink receptivity of the nonwoven. Such coatings are well known in the printing art.

Referring to FIG. 4, after the cylinder is cut along lines 51, individual unfilled bags B are formed by sewing a seam along one of the short edges of the cylinder using a finishing tape 42 as is well known in the bag making art. The bags can then be shipped to a user, who will fill the bags with a desired granular material G and seal the open short edge with a similar finishing tape or other desired closure, resulting in a finished, filled bag 100.

### Other Embodiments

A number of embodiments have been described. Nevertheless, it will be understood that various modifications may be made without departing from the spirit and scope of the disclosure, and that other embodiments are within the scope of the following claims.

What is claimed is:

1. A bag for storing granular material, the bag comprising:
an inner woven polymeric layer,
an outer nonwoven polymeric layer, and
an extruded polymer layer bonding the inner layer to the outer layer.

2. The bag of claim 1, wherein the nonwoven layer comprises a spunbonded material.

3. The bag of claim 1, wherein the nonwoven layer has a basis weight of from about 15 to 80 gsm (grams per square meter).

4. The bag of claim 1, wherein the nonwoven layer has a basis weight of from about 20 to 55 gsm.

5. The bag of claim 1, wherein the nonwoven layer has a basis weight of from about 20 to 40 gsm.

6. The bag of claim 1, wherein the nonwoven layer has a grab tensile strength of at least 20 lb/in.

7. The bag of claim 1, wherein the nonwoven layer comprises a polypropylene or polyethylene nonwoven.

8. The bag of claim 1, wherein the bag has a volume of from about 3 to 30 gallons.

9. The bag of claim 1, wherein the bag is perforated to provide breathability.

10. The bag of claim 1, wherein the inner layer, outer layer, and extruded layer are all of the same material.

11. The bag of claim 1, wherein the inner woven layer has a fabric weight of from about 27 to 135 gsm.

12. The bag of claim 1, wherein the inner woven layer is formed of fibers having a denier of about 500 to 1500.

13. The bag of claim 1, wherein the extruded polymer layer is present in an amount of about 15-25 gsm.

14. A method of making a laminated bag, the method comprising:
forming a laminated material by laminating a nonwoven polymer layer to a woven polymer layer using an extruded polymer layer, and
forming the laminated material into a bag having the nonwoven layer as its outer surface.

15. The method of claim 14, wherein forming the material into a bag includes forming the laminated material into a cylindrical shape with the nonwoven layer exposed, cutting the cylindrical shape to bag length, and sewing the laminated material to form individual bags.

16. The method of claim 14, further comprising printing the nonwoven layer.

17. The method of claim 16, wherein printing is performed prior to forming the laminated material into a bag.

18. The method of claim 14, further comprising perforating the laminated material to provide air holes for breathability.

19. The method of claim 15, wherein sewing step includes applying a finishing tape to the material edges in seam areas and stitching through the finishing tape.

20. The method of claim 14, wherein forming the laminated material comprises heat laminating the layers together.
